(19) United States
(12) Patent Application Publication
(10) Pub. No.: US 2024/0344313 A1
(43) Pub. Date: Oct. 17, 2024

(54) WATER SHUTOFF APPARATUS

(71) Applicant: WATER AUTOMATION, LLC, Point Pleasant, NJ (US)

(72) Inventor: Gregory Capizzi, Point Pleasant, NJ (US)

(21) Appl. No.: 18/632,831

(22) Filed: Apr. 11, 2024

Related U.S. Application Data
(60) Provisional application No. 63/458,524, filed on Apr. 11, 2023.

(51) Int. Cl. E03D 1/00; E03D 11/00

(52) U.S. Cl. CPC E03D 11/00; E03B 7/071; E03D 5/026; G08B 21/20

(57) ABSTRACT

A water shutoff apparatus includes a housing and first and second valves located within the housing. The first and second valves are configured to be fluidly connected to an external appliance and an external first and second water supply lines that provide water at first and second temperatures to an appliance. The first and second valves include an open position, in which the water supply is enabled to supply the water to the appliance, and a closed position, in which the first water supply is prevented from supplying the water to the appliance. The first valve is independent from the second valve. At least one water sensor is electrically connected to the first and second valves. The sensor is operable between an inactivated state and an activated state when wet to activate the first and second valves to move into their closed positions.

### CROSS-REFERENCE TO RELATED APPLICATION

This application is a Section 111 (a) application relating to and claiming the benefit of commonly-owned, co-pending U.S. Provisional Patent Application Ser. No. 63/458,524 filed Apr. 11, 2023 entitled “WATER SHUTOFF APPARATUS,” the contents of which are incorporated herein by reference in its entirety.

### FIELD OF THE INVENTION

The present invention relates to water shut off apparatus and, more particularly, automatic water shutoff apparatus for appliances such as sinks, ice makers, dishwashers, toilets, and water dispensers.

### BACKGROUND OF THE INVENTION

Water from an overflowing appliance such as a sink or damaged water feed pipes to the sink can cause extensive damage to real property. Such damage is magnified in multi-family dwellings, such as apartment buildings and condominiums, where the escaping water from the overflowing sink or damaging pipes in a dwelling unit seeps through the floor and into the ceiling and walls of a dwelling unit located directly below.

### SUMMARY OF THE INVENTION

In some embodiments, an apparatus includes a housing; a first valve located within the housing, wherein the first valve is configured to be fluidly connected to an external appliance and an external first water supply line that provides water at a first temperature to the appliance, wherein the first valve includes an open position, in which the water supply is enabled to supply the water to the appliance, and a closed position, in which the first water supply is prevented from supplying the water to the appliance, a second valve located within the housing, wherein the second valve is configured to be fluidly connected to the external appliance and an external second water supply line that provides water at a second temperature to the appliance, wherein the second valve includes an open position, in which the water supply is enabled to supply the water to the appliance, and a closed position, in which the second water supply is prevented from supplying the water to the appliance, wherein the first valve is independent from the second valve; and at least one water sensor electrically connected to the first valve and the second valve, wherein the water sensor is operable between an inactivated state, in which the water sensor is substantially dry, and an activated state, in which the water sensor is subjected to an amount of water, wherein when the water sensor is in its activated state, either or both of the first valve and the second valve is moved to its closed position.

In some embodiments, each of the first valve and the second valve is an electric motorized valve. In some embodiments, the apparatus includes a controller electrically connected to the first valve and the second valve for controlling the operation of the first valve and the second valve. In some embodiments, the water sensor is external and remote from the housing and is electrically connected to the controller. In some embodiments, the water sensor is electrically connected to the controller by an elongated wire. In some embodiments, the water sensor is adapted to be positioned proximate to a base of the appliance. In some embodiments, the water sensor is adapted to be positioned on a floor of a structure. In some embodiments, the water sensor includes a pair of leads, and wherein the amount of water provides an electrical connection between the leads when the water sensor is in its activated state. In some embodiments, the amount of water is originated from the appliance.

In some embodiments, the apparatus includes a first hose for fluidly connecting the first valve to the appliance, a second hose for fluidly connecting the second valve to the appliance, a third hose for fluidly connecting the first valve to the first water supply, and a fourth hose for fluidly connecting the second valve to the second water supply. In some embodiments, the first valve includes a valve body having a first end and a second end opposite the first end, a first fitting connected to the first end of the first valve, a second fitting connected to the second end of the first valve, wherein the second valve includes a valve body having a first end and a second end opposite the first end of the second valve, a third fitting connected to the first end of the second valve, and a fourth fitting connected to the second end of the second valve. In some embodiments, the apparatus includes a control panel, a first electrical connector electrically connected to the control panel, and a second electrical connector electrically connected to the valve, and wherein the first and second electrical connectors are adapted to removably mate with one another. In some embodiments, the housing includes a base and a cover removably attached to the base, the cover having an external surface, and wherein the control panel is positioned within the cover and accessible by a user from the external surface thereof.

In some embodiments, the apparatus further comprises a power supply. In some embodiments, the power supply includes at least one battery. In some embodiments, the control panel includes at least one visual indicator indicating a status of each of the first valve and the second valve being either in its open position or its closed position. In some embodiments, the housing is adapted to be removably attached to a wall of a structure and positioned proximate to the appliance. In some embodiments, the apparatus is adapted to wirelessly communicate with a remote computer to provide visual and audible alerts to the computer concerning a status of the apparatus. In some embodiments, the appliance is a sink. In some embodiments, the appliance is a clothes washer, a dishwasher, a hot water heater, or a beverage dispenser.

### BRIEF DESCRIPTION OF THE DRAWINGS

FIG. 1 is a front elevational view of some embodiments of a water shutoff apparatus;

FIG. 2 is a rear elevational view of some embodiments of a water shutoff apparatus;

FIG. 3 is a front elevational view of the water shutoff apparatus of FIG. 1 with a front cover employed by the apparatus removed;

FIGS. 4A through 4C illustrate some embodiments of a sensor employed by the water shutoff apparatus shown in FIGS. 1 through 3;

FIG. 5 is a perspective view of the water shutoff apparatus mounted to a wall and connected to a sink and sink water supply lines, the apparatus being shown with the valves in an open position by an associated visual indicator and the sink operating normally;

FIG. 6 is a perspective view of the water shutoff apparatus shown in FIG. 5, but shown with the valves in a closed position by an associated visual indicator as a result of water seepage;

FIG. 7 is a front perspective view of some embodiments of a water shutoff apparatus;

FIG. 8 is a front perspective view of some embodiments of a water shutoff apparatus;

FIG. 9 is a front perspective view of some embodiments of a water shutoff apparatus;

FIG. 10 is a front perspective view of some embodiments of a water shutoff apparatus; and

FIG. 11 is a front perspective view of the water shutoff apparatus shown in FIG. 10 installed in connection with a toilet.

### DETAILED DESCRIPTION OF THE DRAWINGS

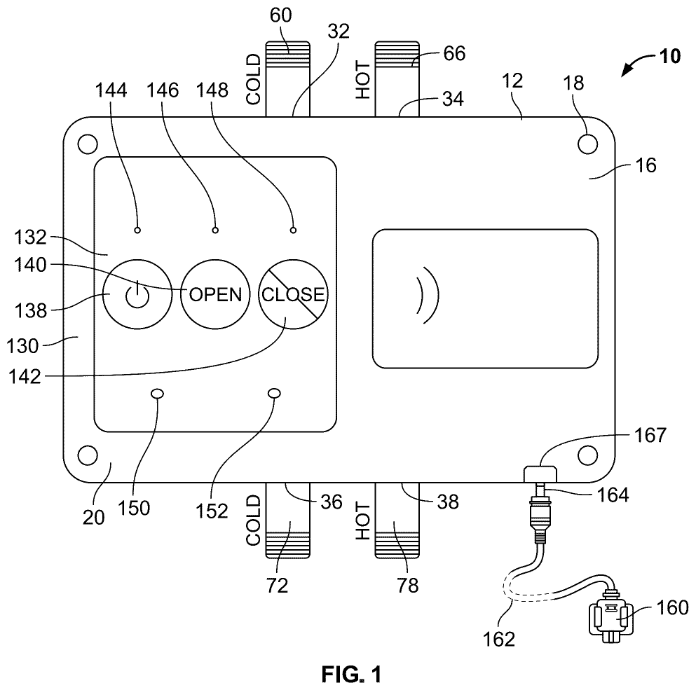

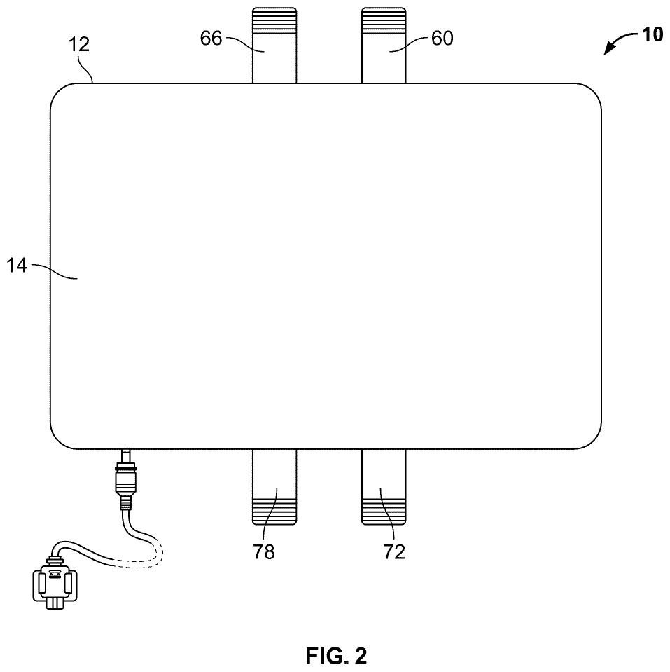

Referring to FIGS. 1 through 3, In some embodiments, a water shutoff apparatus 10 includes a housing 12 having a base 14 and a cover 16 removably attached to the base 14. In some embodiments, the cover 16 is removably attached to the base 14 by a plurality of fasteners 18, such as screws or captive panel fasteners. In another embodiment, the cover 16 is removably attached to the base 14 by other suitable means known in the art, such as snap-fit tabs and joints, hinges, or by interference fit. In some embodiments, a seal such as a gasket, is positioned between the base 14 and the cover 16 to ensure a water-tight seal (not shown in the Figures). In some embodiments, the cover 16 includes a front side 20 and a rear side opposite the front side 20. In some embodiments, the housing 12 includes a top wall 24, a bottom wall 26 opposite the top wall 24, and a pair of sidewalls 28, 30 that extend from the top wall 24 to the bottom wall 26.

In some embodiments, the top wall 24 of the housing 12 includes first and second openings 32, 34 spaced apart from one another. In some embodiments, the first and second openings 32, 34 are distal from one another. In some embodiments, the first and second openings 32, 34 are proximate to one another. In some embodiments, each of the first and second openings 32, 34 is circular in shape.

In some embodiments, the bottom wall 26 of the housing 12 includes third and fourth openings 36, 38 spaced apart from one another. In some embodiments, the third and fourth openings 36, 38 are distal from one another. In some embodiments, the third and fourth openings 36, 38 are proximate to one another. In some embodiments, each of the third and fourth openings 36, 38 is circular in shape.

In some embodiments, the bottom wall 26 includes a fifth opening 40. In some embodiments, the fifth opening 40 is between the sidewalls 28, 30. In some embodiments, the fifth opening 40 is proximate to the first sidewall 28. In some embodiments, the fifth opening 40 is proximate to the second sidewall 30.

In some embodiments, the bottom wall 26 includes a sixth opening 42. In some embodiments, the sixth opening 42 is between the sidewalls 28, 30. In some embodiments, the sixth opening 42 is proximate to the first sidewall 28. In some embodiments, the sixth opening 42 is proximate to the second sidewall 30.

In some embodiments, the housing 12 includes an interior chamber 44 for housing certain components of the apparatus 10, which will be described hereinafter.

In some embodiments, the housing 12 is made from plastic. In some embodiments, the housing 12 is made from a thermoplastic polymer. In some embodiments, the housing 12 is made from acrylonitrile butadiene styrene. In another embodiment, the housing 12 is made of metal. In some embodiments, the housing 12 is made of stainless steel. In some embodiments, the housing 12 may consist of any desired color. In some embodiments, the housing 12 includes a rectangular-shaped cross section. In another embodiment, the housing 12 includes a square-shaped cross section. In another embodiment, the housing 12 includes a circular-shaped cross section. In another embodiment, the housing 12 may consist of other suitable or customized shapes.

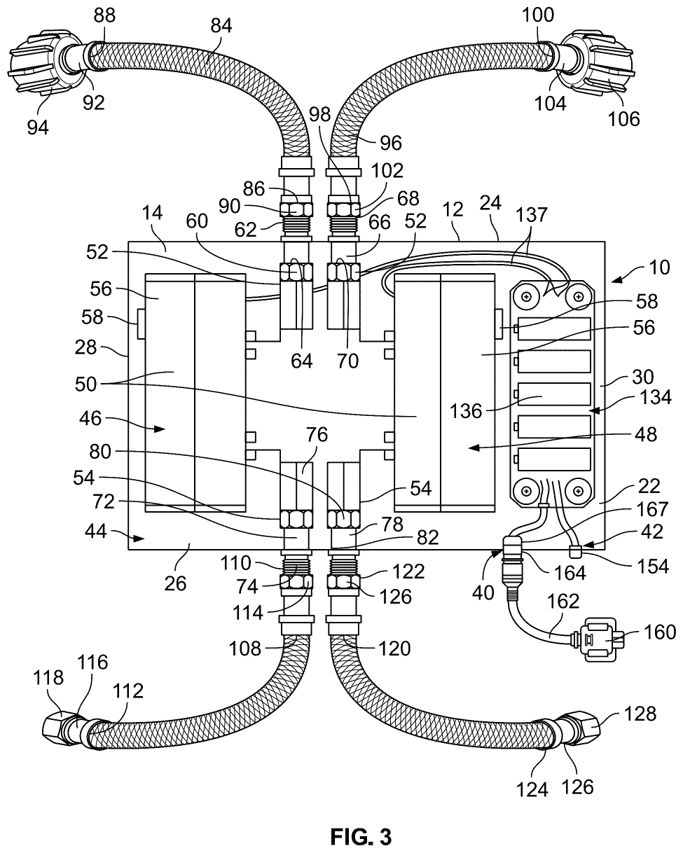

Referring to FIG. 3, in some embodiments, the apparatus 10 includes a first valve 46 and a second valve 48 mounted within the housing 12. In some embodiments, the first valve 46 is separate from the second valve 48. In some embodiments, each of the first valve 46 and the second valve 48 operates independently from one another.

In some embodiments, the first valve 46 is an electric, motorized ball valve. In some embodiments, the second valve 48 is an electric, motorized ball valve. In some embodiments, each of the first valve 46 and the second valve 48 includes a valve body 50 having a first end 52 and a second end 54 opposite the first end 52, and an actuator 56 connected to the valve body 50 intermediate the first and second ends 52, 54 thereof. In some embodiments, the actuator 56 of each of the first valve 46 and the second valve 48 facilitates the opening and closing thereof, respectively.

In some embodiments, each of the first valve 46 and the second valve 48 includes a dial 58. In some embodiments, each of the first and second ends 52, 54 of the valve body 50 of each of the first valve 46 and the second valve 48 include internal threads (not shown in the Figures). In some embodiments, the actuator 56 of each of the first valve 46 and the second valve 48 includes a cable having a male connector. In some embodiments, the male connector is a pin connector. In some embodiments, each of the first valve 46 and the second valve 48 is a component of an electric automatic valve and water leak detector manufactured by Tonhe of China, model number W8-B2-B or model number W15-B2-C. In other embodiments, each of the first valve 46 and the second valve 48 may be made by other manufacturers or consist of other models of electric motorized ball valves. In other embodiments, each of the first valve 46 and the second valve 48 includes a solenoid valve.

Still referring to FIG. 3, in some embodiments, the apparatus 10 includes a first fitting 60. In some embodiments, the first fitting 60 includes a first end 62 and a second end 64 opposite the first end 62. In some embodiments, the first fitting 60 is a male brass fitting. In other embodiments, the first fitting 60 may consist of other suitable fittings. In some embodiments, the first end 62 of the first fitting 60 includes external threads. In some embodiments, the first end 62 of the first fitting 60 extends through the first opening 32. In some embodiments, the second end 64 of the first fitting 60 includes external threads and is threadedly connected to the first end 52 of the valve body 50 of the first valve 46.

Still referring to FIG. 3, in some embodiments, the apparatus 10 includes a second fitting 66. In some embodiments, the second fitting 66 includes a first end 68 and a second end 70 opposite the first end 68. In some embodiments, the second fitting 66 is a male brass fitting. In other embodiments, the second fitting 66 may consist of other suitable fittings. In some embodiments, the first end 68 of the second fitting 66 includes external threads. In some embodiments, the first end 68 of the second fitting 66 extends through the second opening 34. In some embodiments, the second end 70 of the second fitting 66 includes external threads and is threadedly connected to the first end 52 of the valve body 50 of the second valve 48.

Still referring to FIG. 3, in some embodiments, the apparatus 10 includes a third fitting 72. In some embodiments, the third fitting 72 includes a first end 74 and a second end 76 opposite the first end 74. In some embodiments, the third fitting 72 is a male brass fitting. In other embodiments, the third fitting 72 may consist of other suitable fittings. In some embodiments, the first end 74 of the third fitting 72 includes external threads. In some embodiments, the first end 74 of the third fitting 72 extends through the third opening 36. In some embodiments, the second end 76 of the third fitting 72 includes external threads and is threadedly connected to the second end 54 of the valve body 50 of the first valve 46.

Still referring to FIG. 3, in some embodiments, the apparatus 10 includes a fourth fitting 78. In some embodiments, the fourth fitting 78 includes a first end 80 and a second end 82 opposite the first end 80. In some embodiments, the fourth fitting 78 is a male brass fitting. In other embodiments, the fourth fitting 78 may consist of other suitable fittings. In some embodiments, the first end 80 of the fourth fitting 78 includes external threads. In some embodiments, the first end 80 of the fourth fitting 78 extends through the fourth opening 38. In some embodiments, the second end 82 of the fourth fitting 78 includes external threads and is threadedly connected to the second end 54 of the valve body 50 of the second valve 48.

Still referring to FIG. 3, in some embodiments, the apparatus 10 includes a first hose 84 having a first end 86 and a second end 88 opposite the first end 86. In some embodiments, the first end 86 includes a first threaded coupling 90 that is threadedly connected to the first end 62 of the first fitting 60, and the second end 88 includes a second threaded coupling 92 being adapted to threadedly connect to a first sink valve 94.

In some embodiments, the first sink valve 94 is a cold water sink valve. In some embodiments, the first sink valve 94 is a hot water sink valve.

Still referring to FIG. 3, in some embodiments, the apparatus 10 includes a second hose 96 having a first end 98 and a second end 100 opposite the first end 98. In some embodiments, the first end 98 includes a first threaded coupling 102 that is threadedly connected to the first end 68 of the second fitting 66, and the second end 100 includes a second threaded coupling 104 being adapted to threadedly connect to a second sink valve 106. In some embodiments, the second sink valve 106 is a cold water sink valve. In some embodiments, the second sink valve 106 is a hot water sink valve.

Still referring to FIG. 3, in some embodiments, the apparatus 10 includes a third hose 108 having a first end 110 and a second end 112 opposite the first end 110. In some embodiments, the first end 110 includes a first threaded coupling 114 that is threadedly connected to the first end 74 of the third fitting 72, and the second end 112 includes a second threaded coupling 116 being adapted to threadedly connect to a first water supply valve 118. In some embodiments, the first water supply valve 118 is a cold water supply valve. In some embodiments, the first water supply valve 118 is a hot water supply valve.

Still referring to FIG. 3, in some embodiments, the apparatus 10 includes a fourth hose 120 having a first end 122 and a second end 124 opposite the first end 122. In some embodiments, the first end 122 includes a first threaded coupling 126 that is threadedly connected to the first end 80 of the fourth fitting 78, and the second end 124 includes a second threaded coupling 126 being adapted to threadedly connect to a second water supply valve 128. In some embodiments, the second water supply valve 128 is a cold water supply valve. In some embodiments, the second water supply valve 128 is a hot water supply valve.

In some embodiments, each of the hoses 84, 96, 108, 120 is a braided polymer connection hose. In some embodiments, each of the hoses 84, 96, 108, 120 is a ⅜-inch size hose. In another embodiment, each of the hoses 84, 96, 108, 120 is a ¼-inch size hose. In other embodiments, the hoses 84, 96, 108, 120 may consist of other sizes. In some embodiments, each of the fittings 60, 66, 72, 78 is a ⅜-inch size fitting. In another embodiment, each of the fittings 60, 66, 72, 78 is a ¼-inch size fitting. In other embodiments, the fittings 60, 66, 72, 78 may consist of other sizes.

Referring to FIGS. 1 and 3, in some embodiments, the apparatus 10 includes a controller 130 mounted to the cover 16. In some embodiments, the controller 130 includes a control panel 132 accessible from the front side 20 of the cover 16, and battery compartment 134 accessible from the rear side 22 of the cover 16. In some embodiments, the battery compartment 134 is adapted to receive at least one battery 136 for providing power to the controller 130 and the first valve 46 and the second valve 48. In some embodiments, the battery compartment 134 is adapted to receive a plurality of the batteries 136. In some embodiments, the batteries 136 are AA batteries. In other embodiments, the batteries 136 are 9-volt batteries, AAA batteries, 3.5 volt batteries, lithium batteries, or any other standard batteries suitable for providing power to the apparatus 10. In another embodiment, the controller 130 need not include the battery compartment 134 and a separate battery compartment may be positioned elsewhere within the housing 12 and, optionally, accessible through a door or panel in the front side 20 of the cover 16 (not shown in the Figures). In another embodiment, the apparatus 10 may be hardwired into a structure's electrical system. In another embodiment, the apparatus 10 may include a standard electrical plug for electrical connection to a standard power outlet. In some embodiments, electrical wires 137 electrically connect the first valve 46 and the second valve 48 with the controller 130. In some embodiments, the controller 130 is a component of an electric automatic valve and water leak detector manufactured by Tonhe of China, model number W8-B2-B or model number W15-B2-C. In other embodiments, the controller 130 may be made by other manufacturers or consist of other models of suitable controllers.

In some embodiments, the control panel 132 includes a power button 138, at least one valve open button 140, and at least one valve closed button 142. In some embodiments, the at least one valve open button 140 includes a plurality of valve open buttons. In some embodiments, the at least one valve closed button 142 includes a plurality of valve closed buttons. In some embodiments, the at least one valve open button 140 includes a single valve open button 140. In some embodiments, the valve open button 140 controls the opening of the first valve 46. In some embodiments, the valve open button 140 controls the opening of the second valve 48. In some embodiments, the valve open button 140 controls the opening of both the first valve 46 and the second valve 48. In some embodiments, the valve open button 140 controls the opening of both the first valve 46 and the second valve 48 simultaneously. In some embodiments, the valve open button 140 controls the opening of both the first valve 46 and the second valve 48 substantially simultaneously. In some embodiments, the at least one valve open button 140 includes two valve open buttons 140. In some embodiments, the first one of the valve open buttons 140 controls the opening of the first valve 46 independently of the second one of the valve open buttons 140 controlling the opening of the second valve 48, and vice versa.

In some embodiments, the at least one valve closed button 142 includes a single valve closed button 142. In some embodiments, the valve closed button 142 controls the closing of the first valve 46. In some embodiments, the valve closed button 142 controls the closing of the second valve 48. In some embodiments, the valve closed button 142 controls the closing of both the first valve 46 and the second valve 48. In some embodiments, the valve closed button 142 controls the closing of both the first valve 46 and the second valve 48 simultaneously. In some embodiments, the valve closed button 142 controls the closing of both the first valve 46 and the second valve 48 substantially simultaneously. In some embodiments, the at least one valve closed button 142 includes two valve closed buttons 142. In some embodiments, the first one of the valve closed button 142 controls the closing of the first valve 46 independently of the second one of the valve closed buttons 140 controlling the closing of the second valve 48, and vice versa.

In some embodiments, the control panel 132 includes associated power indicator light 144, at least one valve open light 146, and at least one valve closed light 148. In some embodiments, the at least one valve open light 146 is associated with a corresponding one of the at least one valve open button 140. In some embodiments, the at least one valve closed light 148 is associated with a corresponding one of the at least one valve closed button 142. In some embodiments, a battery life indicator may be indicated by lights 150 and 152, which illuminate when the batteries 136 are low. In some embodiments, the cover 16 includes an illumination source 154 electrically connected to the controller 130 for illumination of the apparatus 10 and the associated room or structure. In some embodiments, the illumination source 154 is located within the bottom wall 26 of the cover 16. In other embodiments, the illumination source 154 may be located on the other walls 24, 28, 30 or front side 20 of the cover. In some embodiments, the illumination source 154 is an LED light. In other embodiments, the illumination source 154 may include a plurality of lights, such as multiple LEDs or an LED strip. In some embodiments, the illumination source 154 can be powered on or off by a user from the control panel.

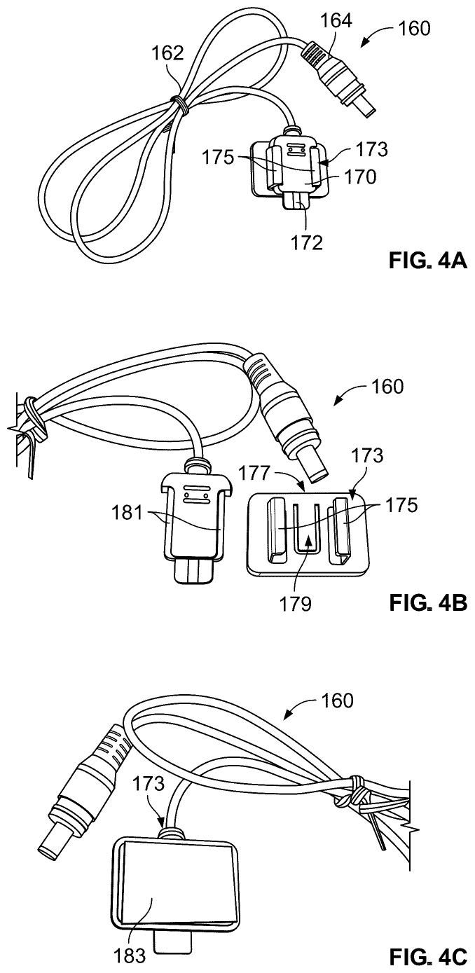

Still referring to FIGS. 1 through 4C, in some embodiments, the apparatus 10 includes at least one flood water sensor 160. In some embodiments, the at least one flood water sensor 160 is electrically connected to the controller 130 by a wire 162. In some embodiments, the wire 162 extends through the sixth opening 42 of the housing 12. In some embodiments, the wire 162 includes a plug 164 at one end thereof. In some embodiments, the housing 12 includes a receptacle 167 that is sized and shaped to mechanically and removably receive the plug 164.

In some embodiments, the wire 162 includes a male connector and a female connector that is sized and shaped to removably mate with the male connector. In some embodiments, the at least one sensor 160 is removably attached to the wire 162 and the sensor 160 is replaceable by disconnecting it from the wire 162 by disconnecting the male and female connectors from one another. In some embodiments, the at least sensor 160 includes a body 170 and at least one lead 172 extending from the body 170. In some embodiments, the body 170 of the at least sensor 160 is substantially flat.

In some embodiments, the at least one sensor 160 is removably attached to a base portion 173. In some embodiments, the base portion 173 includes a first surface and second surface opposite the first surface, and a pair of rails 175 extending from the first surface. In some embodiments, the rails 175 are parallel or substantially parallel to one another. In some embodiments, the rails 175 form a slot 177 therebetween. In some embodiments, a spring tab 179 extends from the first surface. In some embodiments, the at least one sensor 160 includes a pair of grooves 181. In some embodiments, the base portion 173 is configured to removably receive the at least one sensor 160. In some embodiments, the rails 175 of the base portion 173 are sized and shaped to receive the grooves 181 of the at least one sensor 160. In some embodiments, the spring tab 179 removably secures the sensor 160 to the base portion 173. In some embodiments, the sensor 160 may be removed from the base portion 173 by depressing the spring tab 179 by some force.

In some embodiments, the second surface of the base portion 173 includes securing means 183. In some embodiments, the securing means 183 is an adhesive tape. In some embodiments, the adhesive tape is double sided tape. In some embodiments, the securing means is an adhesive. In some embodiments, the securing means could be hook and loop fasteners, other fasteners such as hooks, screws, nails, or bolts. In some embodiments, the base portion 173 may be removably installed on a surface by the securing means 183. In some embodiments, the sensor 160 is removable from the base portion 173 without removing the base portion 173 from the surface.

In some embodiments, the at least one sensor 160 is a wireless sensor. In some embodiments, the wireless sensor includes its own power source. In some embodiments, the wireless sensor communicates with the controller 130 of the housing 12.

In some embodiments, the at least one sensor 160 includes a plurality of the sensors 160. In some embodiments, each of the plurality of the sensors 160 is connected to the controller by a separate wire 162 through the same sixth opening 42 or through different openings of the housing 12. In some embodiments, the housing 12 may include more than one of the sixth openings 42 that are each configured to receive a corresponding one of a plurality of the receptacles 167 to receive the plugs 164 of the plurality of the sensors 160.

In some embodiments, each of the plurality of the sensors 160 includes two of the sensors 160. In some embodiments, one of the plurality of the sensors 160 is a cold water sensor. In some embodiments, the cold water sensor senses water at a first temperature. In some embodiments, the first temperature is 40° F. to 120° F. In some embodiments, the first temperature is 40° F. to 100° F. In some embodiments, the first temperature is 40° F. to 80° F. In some embodiments, the first temperature is 40° F. to 60° F. In some embodiments, the first temperature is 60° F. to 120° F. In some embodiments, the first temperature is 60° F. to 100° F. In some embodiments, the first temperature is 60° F. to 80° F. In some embodiments, the first temperature is 80° F. to 120° F. In some embodiments, the first temperature is 80° F. to 100° F. In some embodiments, the first temperature is 100° F. to 120° F. In some embodiments, another of the plurality of the sensors 160 is a hot water sensor. In some embodiments, the hot water sensor senses water at a second temperature. In some embodiments, the second temperature is 120° F. to 150° F. In some embodiments, the second temperature is 120° F. to 140° F. In some embodiments, the second temperature is 120° F. to 130° F. In some embodiments, the second temperature is 130° F. to 150° F. In some embodiments, the second temperature is 130° F. to 140° F. In some embodiments, the second temperature is 140° F. to 150° F.

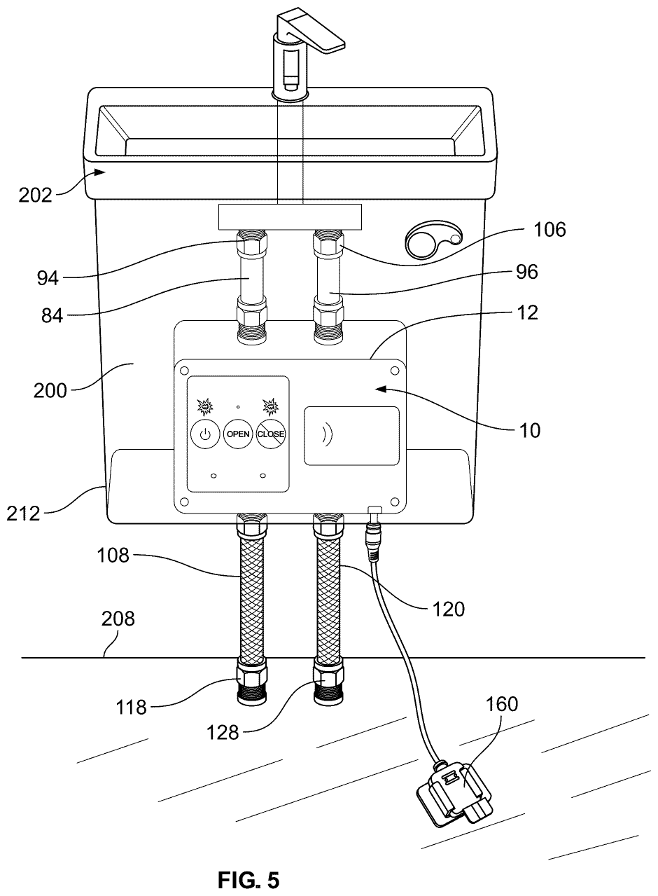

Referring to FIG. 5, in some embodiments, the apparatus 10 is installed on a wall 200 proximate to a sink 202. In some embodiments, the apparatus 10 is installed on a wall beneath the sink 202 and proximate to the water supply valves 118, 128. In some embodiments, the apparatus 10 and particularly the housing 12 is removably attached to the wall 200 by fasteners. In another embodiment, the housing 12 is removably attached to the wall 200 by double-sided tape. In another embodiment, the housing 12 is removably attached to the wall 200 by an adhesive. In another embodiment, the housing 12 is removably attached to the wall 200 by hook and loop fasteners. In other embodiments, the housing 12 is removably attached to the wall 200 by other suitable means known in the art. Preferably, the housing 12 is installed level with a floor 208 of a room where the sink 202 is located. As indicated above, in some embodiments, the second end 88 of the first hose 84 is attached to the first sink valve 94 of the sink 202, and the second end 100 of the second hose 96 is attached to the second sink valve 106 of the sink 202, while the second end 112 of the third hose 108 is attached to the first water supply valve 118 and the second end 124 of the fourth hose 120 is attached to the second water supply valve 128. In some embodiments, each of the first water supply valve 118 and the second water supply valve 128 is engaged in its open position to facilitate the flow of water through the third hose 108 and the fourth hose 120, respectively, the first valve 46 and the second valve 48, respectively, the first hose 84 into the first sink valve 94 and the second hose 96 into the second sink valve 106 to supply water to the sink 202.

In some embodiments, the at least one water sensor 160 is positioned on the surface of the floor 208 proximate to the sink 202. In some embodiments, the at least one water sensor 160 is juxtaposed with a base 212 of the sink 202. In some embodiments, the at least one sensor 160 is approximately ⅛ inch in thickness. In another embodiment, the at least one sensor 160 is approximately 1/16 inch in thickness. In another embodiment, the at least one sensor 160 is attached to the surface of the floor 208. In another embodiment, the sensor 160 is attached to the side of the base 212 of the sink 202, but proximate to the surface of the floor 208. In some embodiments, the sensor 160 is removably attached to the floor 208 or to the base 212 of the sink 202 to maintain its position near or close to the sink 202. In some embodiments, the sensor 160 is attached to the floor 208 or to the base 212 of the sink 202 by an adhesive. In some embodiments, the sensor 160 is attached to the floor 208 or to the base 212 of the sink 202 by double-sided tape or sticky strips. In some embodiments, the wire 162 of the sensor 160 has a length suitable for the sensor 160 to be positioned in any position on the floor 208 near the sink 202 or on the sink 202 proximate to the floor 208.

In some embodiments, the apparatus 10 is powered on by pushing the power button 138 on the control panel 132. The at least one valve open button 140 is depressed to open the first valve 46 and the second valve 48 to their open positions, via the actuators 56. Water flows from the first water supply valve 118 and the second water supply valve 128 through the third hose 108 and the fourth hose 120, respectively, the first valve 46 and the second valve 48, respectively, the first hose 84 into the first sink valve 94 and the second hose 96 into the second sink valve 106 to supply water to the sink 202.

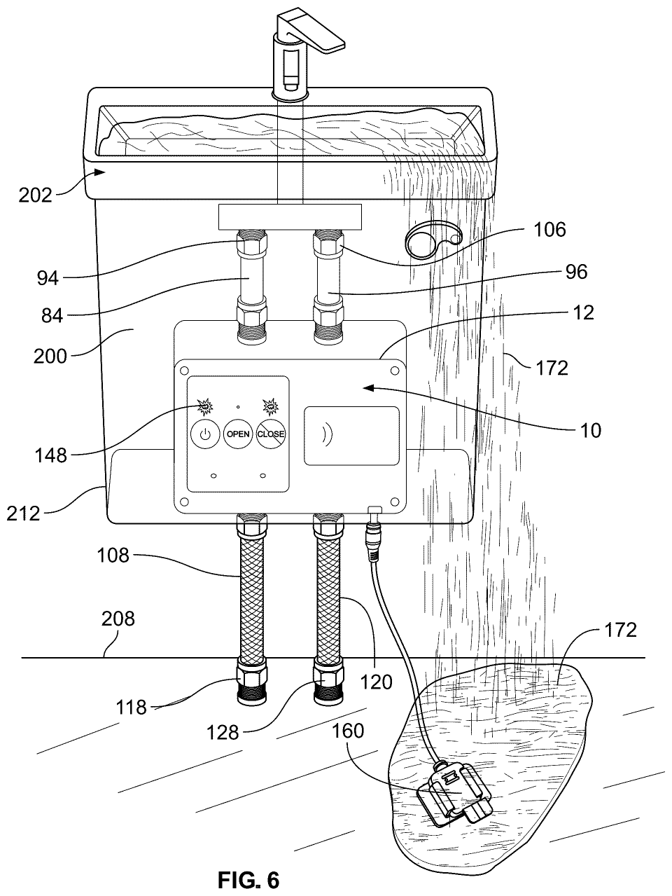

With reference to FIG. 6, in the event of water overflow from the sink 202 over the rim of the sink 202, such as from a clogged sink, a forgotten running sink with the drain plug in a closed position, or faulty hardware; or from water due to faulty or leaky hoses, gaskets or cracks in the sink 202, some water will start to accumulate around or proximate to the base of the sink 202. As shown in FIG. 6, the overflowed water will contact the at least one lead 172 of the at least one sensor 160, which closes the circuit of the sensor 160. In some embodiments, the at least one sensor 160 signals the controller 130 to engage both of the actuators 56 to shut the first valve 46 and the second valve 48 from their open positions to their closed positions, such that the water flow through the apparatus 10 ceases and, in turn, further water flow to the sink 202 ceases, thereby preventing a large accumulation or flood of water on the floor 208 and further preventing damage to the floor 208, surrounding walls, and any other structural elements located below the associated bathroom. With reference to multiple unit and multiple level apartment buildings and condominiums, flood damage to dwelling unit ceilings and walls located below the unit with the subject overflowing or faulty sink or its hardware is avoided, thus saving time and expense for costly repairs. In some embodiments, when the sensor 160 is activated, the controller 130 engages an audible alarm to alert a user of a sink overflow or leakage situation. In addition, the valve off light 148 is engaged notifying a user visually that the first valve 46 and the second valve 48 are in their closed positions.

In some embodiments, the at least one sensor 160 senses and measures the temperature of the leaked water. If the temperature of the water is in a predetermined or programmed cold water temperature range, the controller 130 may engage the actuator 56 to shut the first valve 46 connected to a cold water supply from its open position to its closed position. In some embodiments, the actuator 56 of the second valve 48 connected to the hot water supply remains open to enable a user to still use same and the sink 202. If the temperature of the water is in a predetermined or programmed hot water temperature range, the controller 130 may engage the actuator 56 to shut the second valve 48 connected to a hot water supply from its open position to its closed position. In some embodiments, the actuator 56 of the first valve 46 connected to the cold water supply remains open to enable a user to still use same and the sink 202.

In some embodiments, once the sink overflow or leakage situation has been rectified, the at least one sensor 160 may be dried. In some embodiments, the apparatus 10 is reset by manually resetting the first valve 46 and/or the second valve 48 from its closed position to its open position by depressing the at least one valve open button 142 on the control panel 132, thus re-promoting the flow of water though the apparatus 10 and to the sink 202. In another embodiment, each of the first valve 46 and the second valve 48 can be opened or closed by manually turning the dial of the corresponding actuator 56. In some embodiments, if the batteries 136 are low or out of power or the power is cut off from the apparatus 10, each or both of the first valve 46 and the second valve 48 will automatically close for safety and precautionary purposes. In some embodiments, a user can manually open and close the first valve 46 and the second valve 48 via the dial 58 as necessary, for instance, if there is no power to first valve 46 and the second valve 48 (e.g., dead batteries 136; electrical malfunction; etc.). In some embodiments, if the sensor 160 becomes faulty, broken or worn, or outdated, the sensor 160 may be replaced by disconnecting it from the housing 12 replacing it with a new sensor 160 or a different type of water sensor.

In some embodiments, the at least one sensor 160 includes a plurality of the sensors 160. In some embodiments, the plurality of sensors 160 includes two of the sensors 160. In some embodiments, each of the two sensors 160 senses and measures a temperature of the leaked water. In some embodiments, one of the sensors 160 senses and measures a cold water temperature of the leaked water. In some embodiments, the other of the sensors 160 senses and measures a hot water temperature of the leaked water. If the temperature of the water sensed from one of the sensors 160 is in a predetermined or programmed cold water temperature range, the controller 130 may engage the actuator 56 to shut the first valve 46 connected to a cold water supply from its open position to its closed position. In some embodiments, the actuator 56 of the second valve 48 connected to the hot water supply remains open to enable a user to still use same and the sink 202. If the temperature of the water sensed by the other of the sensors 160 is in a predetermined or programmed hot water temperature range, the controller 130 may engage the actuator 56 to shut the second valve 48 connected to a hot water supply from its open position to its closed position. In some embodiments, the actuator 56 of the first valve 46 connected to the cold water supply remains open to enable a user to still use same and the sink 202.

In some embodiments, if hot water leaks from the sink 202, either from the hot water valve 118 or 128, the first or second sink valves 94, 106, hoses or otherwise, and the initial temperature of the hot water lowers as a result of being exposed to the air for a period of time, the at least one sensor 160 is configured to still sense the presence of water and the controller 130 engages the actuator 56 to shut down one or both of the first valve 46 and the second valve 48.

In some embodiments, the apparatus 10 is adapted to wirelessly, electronically connect to and communicate with and be controlled via Wi-Fi or other electronic signal, a remote computer, such as a personal computer, computer tablet, smart phone, smart watch, or similar personal electronic devices, to provide visual and audible alerts to a user on such personal devices, such as a toilet overflow condition where the sensor 160 is activated and the first valve 46 and/or the second valve 48 closes. In some embodiments, a user may control the apparatus 10 via such personal device. In some embodiments, the apparatus 10 may include a camera and associated camera lens on the housing that provides a user with real time visual alerts of the floor and surrounding areas on her personal electronic smart device's screen. In another embodiment, the apparatus 10 can provide signals and alerts to a central station having a computer system for monitoring multi-dwelling and multi-family units (e.g., apartment buildings, townhouses, and condominiums), such as a real estate superintendent, building maintenance, management company, or other property manager, thus significantly reducing the time between a toilet overflow condition and such personnel receiving the alerts and addressing the condition.

In some embodiments, the apparatus 10 is configured to utilize and be part of a wireless communications protocol for residential and commercial building automation. In some embodiments, the wireless communications protocol includes a mesh-network using low-energy radio waves to communicate from device to device, allowing for wireless control of smart home devices, such as smart lights, security systems, thermostats, sensors, smart door locks, and garage door openers, and including the apparatus 10. In some embodiments, the apparatus 10 is configured to utilize the Z-Wave™ brand of wireless communications protocols. In some embodiments, the apparatus 10 is configured to utilize and communicate wirelessly through other sources of communication such as those by Alexa, Amazon, Google, Building Link, and similar sources. In some embodiments, the apparatus 10 can be controlled from a smart phone, tablet, or computer, and locally through a smart speaker, wireless key fob or wall-mounted panel with a gateway or central control device serving as both the hub and the controller.

In some embodiments, the first valve 46 and/or the second valve 48 are motion activated. In some embodiments, the first valve 46 and/or the second valve 48 are initially in a deactivated, closed position. In some embodiments, the apparatus 10 includes a motion sensor. In some embodiments, when a user approaches the apparatus 10 at a predetermined distance and/or motion, the first valve 46 and/or the second valve 48 are activated and open to allow water flow therethrough. In some embodiments, when the user is no longer present at the predetermined distance, either immediately or after a predetermined period, the first valve 46 and/or the second valve 48 are again deactivated. In some embodiments, the if the at least one sensor 160 senses water, the controller 130 will override any motion sensor and will keep the first valve 46 and/or the second valve 48 in the deactivated state despite the presence of a user or other person at the predetermined distance and/or any motion.

In some embodiments, the apparatus 10 is configured for use in connection with appliances or plumbing devices that have a plurality of water supply lines, such as hot and cold water supply lines, such as clothes washers, dishwashers, beverage dispensing machines (e.g., coffee/tea/hot chocolate/hot water, etc. machines), hot water heaters, and hot and cold water dispensing machines.

The embodiments described herein are merely exemplary and that a person skilled in the art may make many variations and modifications without departing from the spirit and scope of the invention. For example, in certain embodiments, the apparatus 10 can be constructed such that the hoses 84, 96, 108, 120 and the associated fittings 60, 66, 72, 78 extend from any one or other sides or top wall 24, bottom wall 26 and/or sidewalls 28, 30 of the housing 12, depending upon the arrangement and configuration of the water supply valves 118, 128 and the sink 202. In another embodiment, the housing 12 can comprise various sizes and shapes, can be compact, and colors for matching the associated color scheme of the sink 202 and the room containing the sink 202.

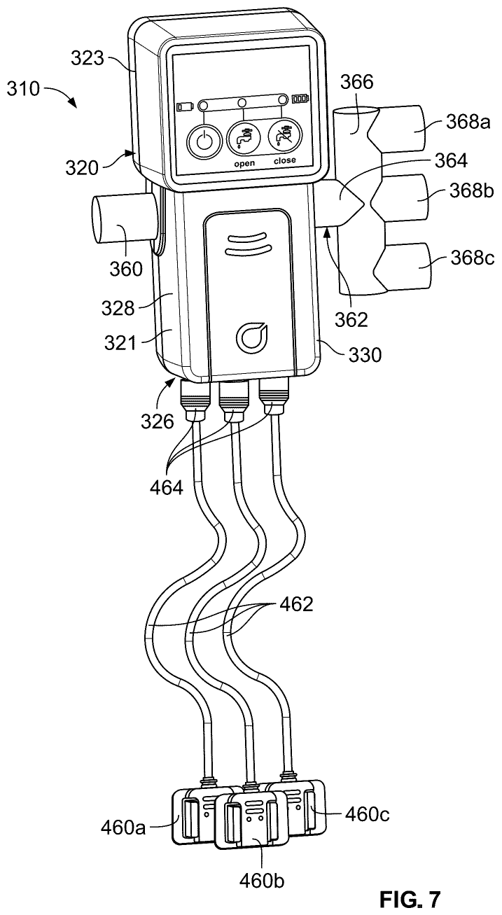

FIG. 7 illustrates an embodiment of a water shutoff apparatus 310. The water shutoff apparatus 310 includes a structure, function, and/or components like those of the water shutoff apparatus 10, except as noted below. In some embodiments, the water shutoff apparatus 310 includes a housing 320 having a first portion 321 and a second portion 323. In some embodiments, the first portion 321 is integral with the second portion 323. In some embodiments, the first portion 321 has a rectangular prism shape. In some embodiments, the second portion 323 has a cube shape. In some embodiments, the first portion 321 includes a first sidewall 328, a second sidewall 330, and a bottom wall 326. In some embodiments, a first fitting 360 extends from the first sidewall 328 and is fluidly connected to a valve body of a valve located within an interior of the first portion 321 of the housing 320 (not shown in FIG. 7). In some embodiments, an actuator of the valve is located within an interior of the second portion 323 of the housing 320. In some embodiments, the first fitting 360 is a ⅜-inch size fitting. In another embodiment, the first fitting 360 is a ¼-inch size fitting. In other embodiments, the first fitting 360 may consist of other sizes. In some embodiments, the first fitting 360 is sized and shaped to removably receive a first hose or tube thereon (not shown). In some embodiments, the hose or tube is fluidly connected to an external water supply line. In some embodiments, the external water supply line is a cold water supply line.

In some embodiments, a second fitting 362 extends from the second sidewall 330 and is fluidly connected to the valve. In some embodiments, the second fitting 362 includes a first portion 364 and a second portion 366 perpendicular to the first portion 364. In some embodiments, a plurality of subbranches 368a, 368b, 368c extend from the second portion 366. In some embodiments, each of the plurality of subbranches 368a, 368b, 368c is sized and shaped to removably receive a corresponding hose or tube thereon (not shown).

In some embodiments, the first subbranch 368a is a ¼-inch size fitting. In another embodiment, the first subbranch 368a is a ⅜-inch size fitting. In another embodiment, the first subbranch 368a is a compression fitting. In other embodiments, the first subbranch 368a may consist of other sizes. In some embodiments, the first subbranch 368a is fluidly connected to a first water appliance or device. In some embodiments, the first appliance or device is an ice maker. In some embodiments, the first appliance or device is a dishwasher. In some embodiments, the first appliance or device is a water sink.

In some embodiments, the second subbranch 368b is a ⅜-inch size fitting. In another embodiment, the second subbranch 368b is a ¼-inch size fitting. In other embodiments, the second subbranch 368b may consist of other sizes. In some embodiments, the second subbranch 368b is fluidly connected to a second water appliance or device. In some embodiments, the second appliance or device is an ice maker. In some embodiments, the second appliance or device is a dishwasher. In some embodiments, the second appliance or device is a water sink.

In some embodiments, the third subbranch 368c is a ⅜-inch size fitting. In another embodiment, the third subbranch 368c is a ¼-inch size fitting. In other embodiments, the third subbranch 368c may consist of other sizes. In some embodiments, the third subbranch 368c is fluidly connected to a third water appliance or device. In some embodiments, the third appliance or device is an ice maker. In some embodiments, the third appliance or device is a dishwasher. In some embodiments, the third appliance or device is a water sink.

In some embodiments, the apparatus 310 includes a plurality of water sensors. In some embodiments, the apparatus 310 includes three water sensors 460a, 460b, 460c. In some embodiments, each of the water sensors 460a, 460b, 460c is electrically connected to the controller by corresponding wire 462. In some embodiments, an electrical connector 464 is connected to each of the wires 462. In some embodiments, the electrical connectors 464 are removably connected to a plug or connection point on the lower wall 326 of the housing 320.

In some embodiments, when the first water sensor 460a is activated upon detection of water on the floor or other surface, the valve shuts of the water supply to at least the first subbranch 368a. In some embodiments, when the first water sensor 460a is activated upon detection of water on the floor or other surface, the valve shuts of the water supply to at least the first subbranch 368a and the second subbranch 368b. In some embodiments, when the first water sensor 460a is activated upon detection of water on the floor or other surface, the valve shuts of the water supply to at least the first subbranch 368a and the third subbranch 368c. In some embodiments, when the first water sensor 460a is activated upon detection of water on the floor or other surface, the valve shuts of the water supply to the first subbranch 368a, the second subbranch 368b and the third subbranch 368c.

In some embodiments, when the second water sensor 460b is activated upon detection of water on the floor or other surface, the valve shuts of the water supply to at least the second subbranch 368b. In some embodiments, when the second water sensor 460b is activated upon detection of water on the floor or other surface, the valve shuts of the water supply to at least the second subbranch 368b and the first subbranch 368a. In some embodiments, when the second water sensor 460b is activated upon detection of water on the floor or other surface, the valve shuts of the water supply to at least the second subbranch 368b and the third subbranch 368c. In some embodiments, when the second water sensor 460b is activated upon detection of water on the floor or other surface, the valve shuts of the water supply to the first subbranch 368a, the second subbranch 368b and the third subbranch 368c.

In some embodiments, when the third water sensor 460c is activated upon detection of water on the floor or other surface, the valve shuts of the water supply to at least the third subbranch 368c. In some embodiments, when the third water sensor 460c is activated upon detection of water on the floor or other surface, the valve shuts of the water supply to at least the third subbranch 368c and the first subbranch 368a. In some embodiments, when the third water sensor 460c is activated upon detection of water on the floor or other surface, the valve shuts of the water supply to at least the third subbranch 368c and the second subbranch 368b. In some embodiments, when the third water sensor 460c is activated upon detection of water on the floor or other surface, the valve shuts of the water supply to the first subbranch 368a, the second subbranch 368b and the third subbranch 368c.

In some embodiments, the second fitting may have more or less subbranches than the first subbranch 368a, the second subbranch 368b and the third subbranch 368c, e.g., two, four, five, six, seven, eight, nine, ten, etc. subbranches.

In some embodiments, the apparatus 310 is configured to be connected to a water supply line of a sink (such as a kitchen sink) to feed water to an ice maker of a refrigerator. In some embodiments, the apparatus 310 is directly connected to the ice maker of the refrigerator.

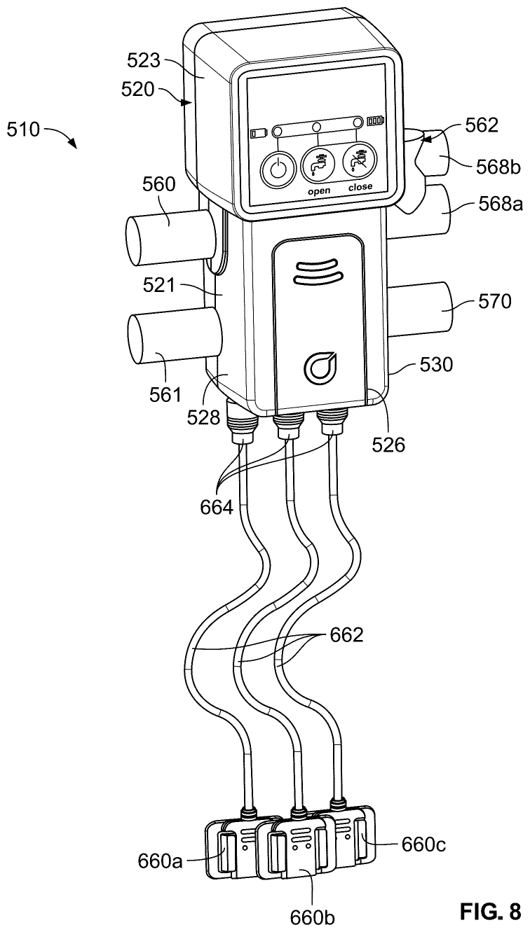

FIG. 8 illustrates an embodiment of a water shutoff apparatus 510. The water shutoff apparatus 510 includes a structure, function, and/or components like those of the water shutoff apparatus 10 and/or the water shutoff apparatus 310 except as noted below. In some embodiments, the water shutoff apparatus 510 includes a housing 520. In some embodiments, the housing 520 includes a first portion 521 and a second portion 523. In some embodiments, the first portion 521 includes a first sidewall 528, a second sidewall 530, and a bottom wall 526. In some embodiments, a first fitting 560 extends from the first sidewall 528 and is fluidly connected to a valve body of a first valve located within an interior of the first portion 521 of the housing 520 (not shown in FIG. 8). In some embodiments, a first actuator of the first valve is located within an interior of the second portion 523 of the housing 520. In some embodiments, a second fitting 561 extends from the first sidewall 528 and is fluidly connected to a second valve located within the interior of the first portion 521 of the housing 520. In some embodiments, a second actuator of the second valve is located within the interior of the first portion 521 of the housing 520. In some embodiments, the apparatus 510 includes a single actuator that controls the first valve and the second valve. In some embodiments, the single actuator is located within the interior of the second portion 523 of the housing 520.

In some embodiments, the first fitting 560 is a ⅜-inch size fitting. In another embodiment, the first fitting 560 is a ¼-inch size fitting. In other embodiments, the first fitting 560 may consist of other sizes. In some embodiments, the first fitting 560 is sized and shaped to removably receive a first hose or tube thereon (not shown). In some embodiments, the first hose or tube is fluidly connected to an external water supply line. In some embodiments, the external water supply line is a cold water supply line. In some embodiments, the external water supply line is a hot water supply line.

In some embodiments, the second fitting 561 is a ⅜-inch size fitting. In another embodiment, the second fitting 561 is a ¼-inch size fitting. In other embodiments, the second fitting 561 may consist of other sizes. In some embodiments, the second fitting 561 is sized and shaped to removably receive a second hose or tube thereon (not shown). In some embodiments, the second hose or tube is fluidly connected to an external water supply line. In some embodiments, the external water supply line is a hot water supply line. In some embodiments, the external water supply line is a cold water supply line.

In some embodiments, a third fitting 562 extends from the second sidewall 530 and is fluidly connected to the valve. In some embodiments, the third fitting 562 includes a plurality of subbranches 568a, 568b. In some embodiments, the subbranches 568a, 568b are fluidly connected. In some embodiments, each of the plurality of subbranches 568a, 568b is sized and shaped to removably receive a corresponding hose or tube thereon (not shown).

In some embodiments, the first subbranch 568a is a ⅜-inch size fitting. In another embodiment, the first subbranch 568a is a ¼-inch size fitting. In other embodiments, the first subbranch 568a may consist of other sizes. In some embodiments, the first subbranch 568a is fluidly connected to a first water appliance or device. In some embodiments, the first appliance or device is a sink. In some embodiments, the first subbranch 568a is fluidly connected to a cold water supply of the sink.

In some embodiments, the second subbranch 568b is a ¼-inch size fitting. In another embodiment, the second subbranch 568b is a ⅜-inch size fitting. In other embodiments, the second subbranch 568b may consist of other sizes. In another embodiment, the second subbranch 568b is a compression fitting. In some embodiments, the second subbranch 568b is fluidly connected to a second water appliance or device. In some embodiments, the second appliance or device is an ice maker. In some embodiments, the second appliance or device is a dishwasher. In some embodiments, the second appliance or device is a water sink.

In some embodiments, the apparatus 510 includes a fourth fitting 570 extending from the second sidewall 530 and is fluidly connected to the valve. In some embodiments, the fourth fitting 570 is a ⅜-inch size fitting. In another embodiment, the fourth fitting 570 is a ¼-inch size fitting. In other embodiments, the fourth fitting 570 may consist of other sizes. In some embodiments, the fourth fitting 570 is fluidly connected to a first water appliance or device. In some embodiments, the first appliance or device is a sink. In some embodiments, the fourth fitting 570 is fluidly connected to a hot water supply of the sink. In some embodiments, the first subbranch 568a of the third fitting 562 is fluidly connected to the cold water supply of a sink and the fourth fitting 570 is fluidly connected to the hot water supply of the same sink.

In some embodiments, the apparatus 510 includes a plurality of water sensors. In some embodiments, the apparatus 510 includes three water sensors 660a, 660b, 660c. In some embodiments, each of the water sensors 660a, 660b, 660c is electrically connected to the controller by corresponding wire 662. In some embodiments, an electrical connector 664 is connected to each of the wires 662. In some embodiments, the electrical connectors 664 are removably connected to a plug or connection point on the lower wall 526 of the housing 520.

In some embodiments, when the first water sensor 660a is activated upon detection of water on the floor or other surface, the valve shuts of the water supply to at least the first subbranch 568a. In some embodiments, when the first water sensor 660a is activated upon detection of water on the floor or other surface, the valve shuts of the water supply to at least the first subbranch 568a and the second subbranch 568b. In some embodiments, when the first water sensor 660a is activated upon detection of water on the floor or other surface, the valve shuts of the water supply to at least the first subbranch 568a and the fourth fitting 570. In some embodiments, when the first water sensor 660a is activated upon detection of water on the floor or other surface, the valve shuts of the water supply to the first subbranch 568a, the second subbranch 568b and the fourth fitting 570.

In some embodiments, when the second water sensor 660b is activated upon detection of water on the floor or other surface, the valve shuts of the water supply to at least the second subbranch 568b. In some embodiments, when the second water sensor 660b is activated upon detection of water on the floor or other surface, the valve shuts of the water supply to at least the second subbranch 568b and the first subbranch 568a. In some embodiments, when the second water sensor 660b is activated upon detection of water on the floor or other surface, the valve shuts of the water supply to at least the second subbranch 568b and the fourth fitting 570. In some embodiments, when the second water sensor 660b is activated upon detection of water on the floor or other surface, the valve shuts of the water supply to the first subbranch 568a, the second subbranch 568b and the fourth fitting 570.

In some embodiments, when the third water sensor 660c is activated upon detection of water on the floor or other surface, the valve shuts of the water supply to at least the fourth fitting 570. In some embodiments, when the third water sensor 660c is activated upon detection of water on the floor or other surface, the valve shuts of the water supply to at least fourth fitting 570 and the first subbranch 568a. In some embodiments, when the third water sensor 660c is activated upon detection of water on the floor or other surface, the valve shuts of the water supply to at least the fourth fitting 570 and the second subbranch 568b. In some embodiments, when the third water sensor 660c is activated upon detection of water on the floor or other surface, the valve shuts of the water supply to the first subbranch 568a, the second subbranch 568b and the fourth fitting 570.

In some embodiments, the third fitting 562 may have more or less subbranches than the first subbranch 568a and the second subbranch 568b, e.g., one three, four, five, six, seven, eight, nine, ten, etc. subbranches. In some embodiments, the apparatus 510 includes more or less corresponding sensors than the sensors 660a, 660b, 660c, e.g., two, four, five, six, seven, eight, nine, ten, etc. sensors.

In some embodiments, the apparatus 510 includes a manifold within the housing 520. In some embodiments, the valve is connected to manifold. In some embodiments, the valve is a spline valve. In some embodiments, the valve and manifold prevent the mixture of cold and hot water from the cold and hot water supply lines through the first fitting 560 and the second fitting 561.

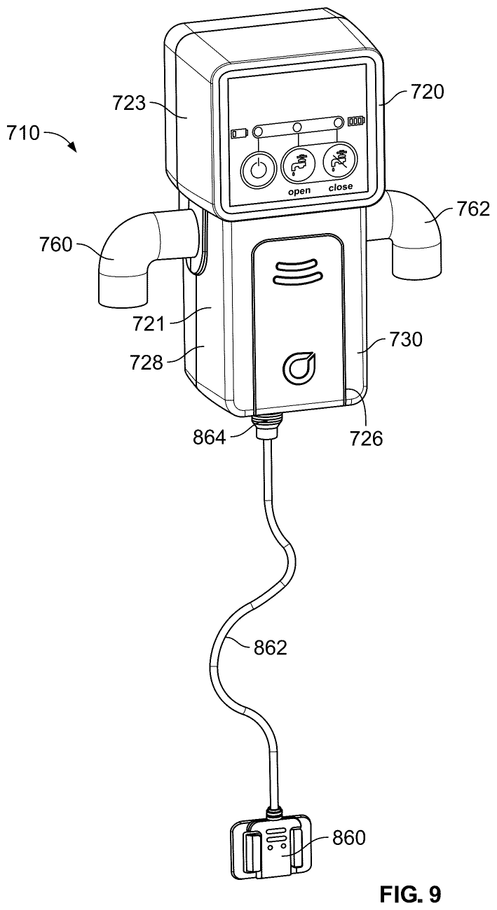

FIG. 9 illustrates an embodiment of a water shutoff apparatus 710. The water shutoff apparatus 710 includes a structure, function, and/or components similar to those of the water shutoff apparatus 10, the water shutoff apparatus 310 and/or the water shutoff apparatus 510, except as noted below. In some embodiments, the water shutoff apparatus 710 includes a housing 720 having a first portion 721 and a second portion 723. In some embodiments, the first portion 721 includes a first sidewall 728, a second sidewall 730, and a bottom wall 726. In some embodiments, a first fitting 760 extends from the first sidewall 728 and is fluidly connected to a valve body of a valve located within an interior of the first portion 721 of the housing 720 (not shown in FIG. 9). In some embodiments, an actuator of the valve is located within an interior of the second portion 723 of the housing 720. In some embodiments, a second fitting 762 extends from the second sidewall 728 and is fluidly connected to the valve located within the interior of the first portion 721 of the housing 720.

In some embodiments, the first fitting 760 is a ¼-inch size fitting. In another embodiment, the first fitting 760 is a ⅜-inch size fitting. In other embodiments, the first fitting 760 may consist of other sizes. In another embodiment, the first fitting 760 is a compression fitting. In some embodiments, the first fitting 760 is sized and shaped to removably receive a first hose or tube thereon (not shown). In some embodiments, the first hose or tube is fluidly connected to an external water supply line. In some embodiments, the external water supply line is a cold water supply line.

In some embodiments, the second fitting 762 is a ¼-inch size fitting. In another embodiment, the second fitting 762 is a ⅜-inch size fitting. In other embodiments, the second fitting 762 may consist of other sizes. In another embodiment, the second fitting 762 is a compression fitting. In some embodiments, the second fitting 762 is sized and shaped to removably receive a second hose or tube thereon (not shown). In some embodiments, the second hose or tube is fluidly connected to an external water supply line. In some embodiments, the external water supply line is a cold water supply line. In some embodiments, the external water supply line is fluidly and/or mechanically connected to an appliance or device. In some embodiments, the appliance or device is an ice maker.

In some embodiments, the apparatus 710 includes at least one water sensor 860. In some embodiments, when the at least one water sensor 860 is activated upon detection of water on the floor or other surface, the valve shuts of the water supply to at least the second fitting 762. In some embodiments, the at least one water sensor 860 is electrically connected to the controller by a wire 862. In some embodiments, an electrical connector 864 is connected to the wire 862. In some embodiments, the electrical connector 864 is removably connected to a plug or connection point on the lower wall 726 of the housing 920.

In some embodiments, the apparatus 710 may have more than one of the fittings 762 extending from the sidewall 730, e.g., two, three, four, five, six, seven, eight, nine, ten, etc. fittings. In some embodiments, the apparatus 710 includes more corresponding sensors than the sensors 860, e.g., two, three, four, five, six, seven, eight, nine, ten, etc. sensors.

In some embodiments, the apparatus 710 is configured to be connected to a water supply line of a sink (such as a kitchen sink) to feed water to an ice maker of a refrigerator. In some embodiments, the apparatus 710 is directly connected to the ice maker of the refrigerator.

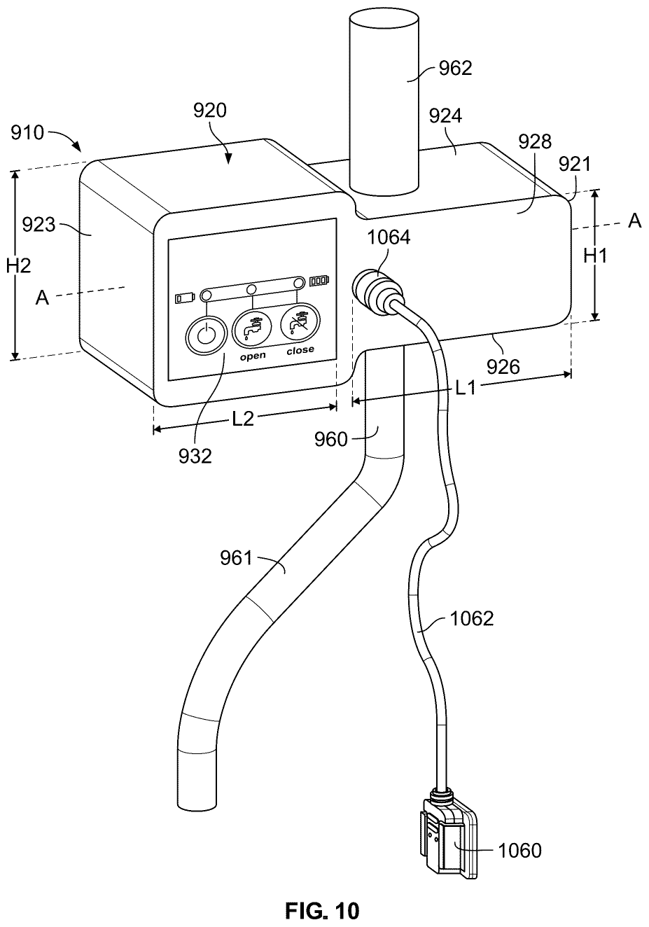

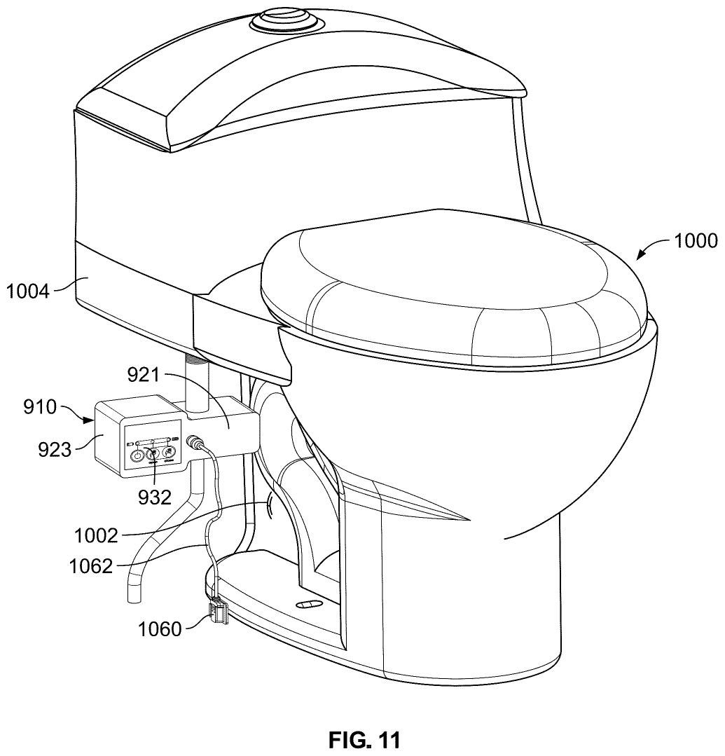

FIGS. 10 and 11 illustrate an embodiment of a water shutoff apparatus 910. The water shutoff apparatus 910 includes a structure, function, and components similar to those of the water shutoff apparatus 10, the water shutoff apparatus 310, the water shutoff apparatus 510, and the water shutoff apparatus 710, except as noted below. In some embodiments, the water shutoff apparatus 910 includes a housing 920. In some embodiments, the housing 920 is elongated and has a longitudinal axis A-A.

In some embodiments, the housing 920 includes a first portion 921 and a second portion 923. In some embodiments, the first portion 921 is integral with the second portion 923. In some embodiments, the first portion 921 has a rectangular prism shape. In some embodiments, the second portion 923 has a cube shape. In some embodiments, the first portion 921 includes a first height H1. In some embodiments, the second portion 923 includes a second height H2. In some embodiments, the second height H2 of the second portion 923 is greater than the first height H1 of the first portion 921. In some embodiments, the first portion 921 includes a first length L1. In some embodiments, the second portion 923 includes a second length L2. In some embodiments, the first length L1 of the first portion 921 is greater than the second length L1 of the second portion 923.

In some embodiments, the first portion 921 includes a top wall 924, a bottom wall 926, and a front wall 928. In some embodiments, a first fitting 960 extends from the bottom wall 926 and is fluidly connected to a valve body of a valve located within an interior of the first portion 921 of the housing 920 (not shown in FIG. 10). In some embodiments, an actuator of the valve is located within an interior of the second portion 923 of the housing 920. In some embodiments, a second fitting 962 extends from the top wall 924 and is fluidly connected to the valve.

In some embodiments, the second portion 923 includes a control panel 932. In some embodiments, the control panel 932 includes one or more features as described above. In some embodiments, the control panel 932 is a touch screen. In some embodiments, the second portion 923 includes a battery compartment.

In some embodiments, the first fitting 960 is a ⅜-inch size fitting. In other embodiments, the first fitting 960 may consist of other sizes. In some embodiments, the first fitting 960 is sized and shaped to removably receive a first hose or tube thereon 961. In some embodiments, the first hose or tube is fluidly connected to an external water supply line. In some embodiments, the external water supply line is a cold water supply line. In some embodiments, the external water supply line is a toilet water supply line.

In some embodiments, the second fitting 962 is a ⅞-inch size fitting. In other embodiments, the second fitting 962 may consist of other sizes. In some embodiments, the second fitting 962 is sized and shaped to removably receive a second hose or tube thereon (not shown). In some embodiments, the second hose or tube is fluidly connected to an external water supply line. In some embodiments, the external water supply line is a cold water supply line.

In some embodiments, the second fitting 962 is directly attached to an appliance or device. In some embodiments, the appliance or device is a toilet bowl 1000 (see FIG. 11). In some embodiments, the fitting 962 is fluidly and/or mechanically connected to a toilet fill valve of the toilet bowl 1000. In some embodiments, the apparatus 910 does not require a separate hose or tube for the second fitting 962 to be attached to the toilet fill valve. In some embodiments, the apparatus 910 only includes the first fitting 960 and the second fitting 962.

In some embodiments, the apparatus 910 is installed such that the housing 920 is positioned horizontally or substantially horizontally along its longitudinal axis A-A. In some embodiments, the length L1 of the first portion 921 of the housing 920 and the length L2 of the second portion 923 is selected such that second portion 923 is positioned with sufficient clearance away from a base 1002 and a tank 1004 of the toilet bowl 1000 so that a user can easily access the control panel 932 and/or the battery compartment of the apparatus 910.

In some embodiments, the apparatus 910 includes at least one water sensor 1060. In some embodiments, the at least one water sensor 1060 is electrically connected to a controller within the housing 920 (not shown in FIG. 10). In some embodiments, the at least one water sensor 1060 is electrically connected to the controller by a wire 1062. In some embodiments, an electrical connector 1064 is connected to the wire 1062. In some embodiments, the electrical connector 1064 is removably connected to a plug or connection point on the front wall 928 of the housing 920. In some embodiments, when the at least one water sensor 1060 is activated upon detection of water on the floor or other surface, the valve shuts of the water supply to at least the second fitting 962. In some embodiments, the apparatus 910 includes components, functions, structure and/or features with those of the apparatus disclosed in U.S. Pat. No. 10,895,068, issued Jan. 19, 2021, which is incorporated by reference herein in its entirety and made a part hereof.

The embodiments described herein are merely exemplary and that a person skilled in the art may make many variations and modifications without departing from the spirit and scope of the invention. All such variations and modifications are intended to be included within the scope of the invention as defined in the specification.

What is claimed is:

1. An apparatus, comprising:
a housing;
a first valve located within the housing,
wherein the first valve is configured to be fluidly connected to an external appliance and an external first water supply line that provides water at a first temperature to the appliance,
wherein the first valve includes an open position, in which the first water supply line is enabled to supply the water to the appliance, and a closed position, in which the first water supply line is prevented from supplying the water to the appliance,
a second valve located within the housing,
wherein the second valve is configured to be fluidly connected to the external appliance and an external second water supply line that provides water at a second temperature to the appliance,
wherein the second valve includes an open position, in which the second water supply line is enabled to supply the water to the appliance, and a closed position, in which the second water supply line is prevented from supplying the water to the appliance,
wherein the first valve is independent from the second valve; and
at least one water sensor electrically connected to the first valve and the second valve, wherein the at least one water sensor is operable between an inactivated state, in which the at least one water sensor is substantially dry, and an activated state, in which the at least one water sensor is subjected to an amount of water, wherein when the at least one water sensor is in its activated state, either or both of the first valve and the second valve is moved to its closed position.

2. The apparatus of claim 1, wherein each of the first valve and the second valve is an electric motorized valve.

3. The apparatus of claim 2, further comprising a controller electrically connected to the first valve and the second valve for controlling an operation of the first valve and the second valve.

4. The apparatus of claim 3, wherein the at least one water sensor is external and remote from the housing and is electrically connected to the controller.

5. The apparatus of claim 4, wherein the at least one water sensor is electrically connected to the controller by an elongated wire.

6. The apparatus of claim 5, wherein the at least one water sensor is adapted to be positioned proximate to a base of the appliance.

7. The apparatus of claim 6, wherein the at least one water sensor is adapted to be positioned on a floor of a structure.

8. The apparatus of claim 7, wherein the at least one water sensor includes a pair of leads, and wherein the amount of water provides an electrical connection between the leads when the at least one water sensor is in its activated state.

9. The apparatus of claim 8, wherein the amount of water is originated from the appliance.

10. The apparatus of claim 1, further comprising a first hose for fluidly connecting the first valve to the appliance, a second hose for fluidly connecting the second valve to the appliance, a third hose for fluidly connecting the first valve to the first water supply line, and a fourth hose for fluidly connecting the second valve to the second water supply line.

11. The apparatus of claim 10, wherein the first valve includes a valve body having a first end and a second end opposite the first end, a first fitting connected to the first end of the first valve, a second fitting connected to the second end of the first valve, wherein the second valve includes a valve body having a first end and a second end opposite the first end of the second valve, a third fitting connected to the first end of the second valve, and a fourth fitting connected to the second end of the second valve.

12. The apparatus of claim 3, further comprising a control panel, a first electrical connector electrically connected to the control panel, and a second electrical connector electrically connected to the first valve and the second valve, and wherein the first electrical connector and the second electrical connector are adapted to removably mate with one another.

13. The apparatus of claim 12, wherein the housing includes a base and a cover removably attached to the base, the cover having an external surface, and wherein the control panel is positioned within the cover and accessible by a user from the external surface thereof.

14. The apparatus of claim 12, further comprising a power supply.

15. The apparatus of claim 14, wherein the power supply includes at least one battery.

16. The apparatus of claim 12, wherein the control panel includes at least one visual indicator indicating a status of each of the first valve and the second valve being either in its open position or its closed position.

17. The apparatus of claim 1, wherein the housing is adapted to be removably attached to a wall of a structure and positioned proximate to the appliance.

18. The apparatus of claim 12, wherein the apparatus is adapted to wirelessly communicate with a remote computer to provide visual and audible alerts to the computer concerning a status of the apparatus.

19. The apparatus of claim 1, wherein the appliance is a sink.

20. The apparatus of claim 1, wherein the appliance is a clothes washer, a dishwasher, a hot water heater, or a beverage dispenser.
